(19) United States
(12) Patent Application Publication
(10) Pub. No.: US 2007/0232512 A1
(43) Pub. Date: Oct. 4, 2007

(54) Cleaning solution for substrate for use in semiconductor device and cleaning method using the same

(75) Inventor: Yoshinori Nishiwaki, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,541

(22) Filed: Mar. 27, 2007

(30) Foreign Application Priority Data
Mar. 30, 2006 (JP) 2006-095445

(51) Int. Cl. C11D 7/32

(52) U.S. Cl. 510/175

(57) ABSTRACT

A cleaning solution for a substrate for use in a semiconductor device, which is used after a chemical mechanical polishing process in a semiconductor device production process, the cleaning solution containing a nonionic surfactant represented by the following formula (I), an organic acid, and a polyethylene glycol having a number average molecular weight of 5000 or less, wherein the pH of the cleaning solution 5 or less, as well as a cleaning method using the cleaning solution.

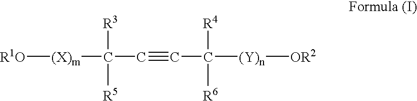

In the formula (I), R¹ to R⁶ each independently represent a hydrogen atom or alkyl group having 1 to 10 carbon atoms, X and Y each independently represent an ethyleneoxy group or propyleneoxy group, and m and n each independently represent an integer from 0 to 20.

### CROSS-REFERENCE TO RELATED APPLICATION

This application claims priority under 35 USC 119 from Japanese Patent Application No. 2006-095445, the disclosure of which is incorporated by reference herein.

### BACKGROUND OF THE INVENTION

1. Field of the Invention

The present invention relates to a cleaning solution used, after planarization by Chemical Mechanical Polishing (hereinafter, sometimes referred to as “CMP”), in a cleaning process in production of a semiconductor device, a cleaning process of a substrate for semiconductor device use, and a cleaning method using the same.

2. Description of the Related Art

In the development of semiconductor devices, typified by semiconductor integrated circuits (hereinafter, referred to as “LSI”), the following processes are generally carried out. Often a shallow trench isolation (STI) film, which is also known as an element separation film, is formed at a lower portion of a substrate, and then multiple layers, such as insulation film(s) and metal film(s) are laminated thereon to compose a multilayered laminated structure. When laminating multiple layers, an interlayer insulation film using an ordinary interlayer insulation film such as a p-TEOS film or an O₃-TEOS film, as well as an interlayer insulation film (interlayer dielectric (ILD) films) including an interlayer film having a low dielectric constant of about 3.5 to 2.0 (for example, an organic polymer based film, a methyl group containing silica based film, a H—Si containing silica based film, a SiOF based film, a porous silica based film, and a porous organic material based film, which are usually referred to as low-k films), and metal films are deposited on the substrate. Then the resulting unevenness due to the deposition process is planarized by carrying out a planarizing treatment by CMP, and new wiring is laminated on the planarized surface.

In recent years, along with progress in reducing the width of lines of semiconductor devices, planarity at high accuracy has becoming more and more necessary in each of the layers of the substrate.

Accordingly, the expectations on CMP are high, and a planarizing process by CMP is becoming popular in production processes for semiconductor devices, and the subsequent cleaning process is also playing an important role.

In the planarizing processes by CMP, for a single substrate specific polishing slurries are used for each film depending on the property of the film(s) to be polished and planarized, and polishing conditions and polishing liquids are generally changed in plural planarizing processes. Depending on the planarizing process, the composition and components of cleaning solution used after CMP are also different.

Abrasives contained in a polishing liquid, which is used for a low-k film or a film mainly composed of silica such as an ILD film and a STI film, include finely particulate powder of fumed silica, colloidal silica, and cerium oxide. The polishing liquid used is one prepared by dispersing the abrasives in water. In the polishing liquid described above, a water-soluble macromolecule, a surfactant, inorganic salt, and a precipitation inhibitor, and the like are used in combination as additives. Further, abrasive-free polishing liquids containing no abrasives at all, and polishing liquids containing extremely small amounts of abrasives, are also used.

A polishing liquid containing combinations of an oxidizing agent such as hydrogen peroxide, iron nitrate, and hydroxy amine, an abrasive such as finely particulate alumina, fumed silica, and colloidal silica, and a chelating agent and, further, containing a corrosion inhibitor, and other additives, is used for metal films such as of Cu, W or Al, or nitride films.

After the CMP process for planarization, some of the polished-away metal or abrasive grains are left on the wafer surface. With an aim of removing such contaminating grains or metals to a desired level, a cleaning process of using a cleaning solution is usually provided. As the cleaning solution used in the cleaning process, a cleaning solution containing a specified surfactant and alkali or organic acid (refer, for example, to JP-A No. 2003-289060): and a cleaning solution containing an organic acid, organic alkali, and surfactant (refer, for example, to JP-A No. 2005-160213) have been proposed.

In the cleaning process after the Cu-CMP process, when a generally used acidic cleaning solution (hydrochloric acid or hydrofluoric acid) is used as the cleaning solution for semiconductors, not only copper oxide deposited on the insulative film but also metal copper of circuits is dissolved. As a result, since this results in corrosion or disconnection of circuits, use of the acidic cleaning solution is not preferred. For the removal of inorganic or organic impurities or particles such as abrasive grains, an alkaline cleaning solution causing electrostatic repulsion between a semiconductor surface and particles is considered to be effective. However, in a case of using a cleaning solution such as of sodium hydroxide or potassium hydroxide containing metal ions as an alkali source, the metals are adsorbed to the surface of the insulative film (silicon oxide) to deteriorate insulation characteristics. Further, among the alkaline cleaning solutions, a cleaning solution of an inorganic alkali not containing metal ions (aqueous ammonia or the like) has an intense copper dissolving effect. A cleaning solution containing quaternary ammonium strongly etches an insulating film, unfavorably roughening the surface planarized in the CMP process. These all leave something to be desired, from the view point of efficiently removing metals polished away from the article to be polished and organic residues or fine abrasive grains remaining on the substrate surface. Proposed remedies include, for example, high pressure water jetted out from a nozzle end in the cleaning process which generates a great amount of mist on the surface of the semiconductor substrate discharging most particles there through an exhaust port. However, a considerable portion of them are suspended in the chamber and the particles suspended in the mist are again deposited to the surface of the semiconductor substrate. The mists sometimes contain dusts in a gas phase which adsorb on mist droplets. In a case where the water in the mist is evaporated after deposition, the dust is left and attaches to the surface of the semiconductor substrate, where it is difficult to remove. Further, also in a case where dust-free mist deposited on the surface of the semiconductor substrate content is evaporated, traces of the mist are sometimes left as so-called water marks.

### SUMMARY OF THE INVENTION

The invention provides a cleaning solution for a substrate for use in a semiconductor device, which is used after a chemical mechanical polishing process in a semiconductor device production process, the cleaning solution comprising a nonionic surfactant represented by the following formula (I), an organic acid, and a polyethylene glycol having a number average molecular weight of 5,000 or less, wherein the pH of the cleaning solution is 5 or less:

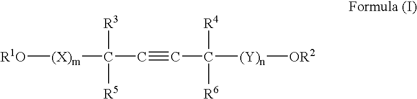

In the formula (I), R¹ to R⁶ each independently represents a hydrogen atom or an alkyl group having 1 to 10 carbon atoms X and Y each independently represents an ethyleneoxy group or propyleneoxy group, and m and n each independently represents an integer of 0 to 20.

Further, another invention provides a cleaning method for a substrate for use in a semiconductor device using the cleaning solution of the invention described above.

The invention can be applied to a cleaning process after a planarizing polishing process in a semiconductor device production process and is capable of efficiently removing particles, for example, of impurity metals, impurity organic or inorganic materials, abrasive grains present on the surface of metal film including a circuit, device isolation films, inter-layer insulative films, nitride films, etc.

### DETAILED DESCRIPTION OF THE INVENTION

Specific embodiments of the present invention are to be described below.

The cleaning solution of the invention contains (A) a nonionic surfactant represented by the formula (I), (B) an organic acid, and (C) a polyethylene glycol having a number average molecular weight of 5,000 or less (hereinafter also simply referred to as “polyethylene glycol”). Then, it is used for cleaning a substrate for use in a semiconductor device after a chemical mechanical polishing process in a semiconductor device production process.

Each of the ingredients contained in the cleaning solution of the invention is to be described successively.

[Nonionic Surfactant Represented by the Formula (I)]

The cleaning solution of the invention contains a nonionic surfactant represented by the following formula (I) (hereinafter referred to optionally as a specific compound).

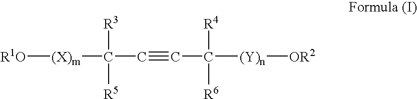

In the formula (I), R¹ to R⁶ each independently represents a hydrogen atom or an alkyl group having 1 to 10 carbon atoms X and Y each independently represents an ethyleneoxy group or propyleneoxy group, and m and n each independently represents an integer of 0 to 20.

Further, in the formula (I), R¹ and R² each independently represents a hydrogen atom or an alkyl group having 1 to 10 carbon atoms, preferably a hydrogen atom, methyl group, ethyl group, propyl group, or isopropyl group and, more preferably, the hydrogen atom. In the formula (I), R³ to R⁶ each independently represents a hydrogen atom or an alkyl group having 1 to 10 carbon atoms, preferably, a methyl group, ethyl group, propyl group, isopropyl group, butyl group or 2-methylpropyl group and, more preferably, methyl group or 2-methylpropyl group.

In the formula (I), X and Y each represents an ethyleneoxy group (—CH₂CH₂O—) or propyleneoxy group (—CH₂CH₂CH₂O—, —CH₂CH(CH₃)O— or —CH(CH₃)CH₂O—), more preferably —CH₂CH₂O—, —CH₂CH(CH₃)O—, or —CH(CH₃)CH₂O— and still more preferably, —CH₂CH₂O—.

Further, in a case where m is 0 as will be described later, X represents a single bond. In the same manner, in a case where n is 0, Y represents a single bond. Further, in a case where X and/or Y are a propyleneoxy group and the corresponding m or n is 2 or more, the oxyethylene structure and the propyleneoxy structure described above may be present together. Further, the ethyleneoxy group and the propyleneoxy group in X or Y are bonded with R¹O— or R²O— by means of carbon atoms.

In the formula (I), m and n each independently represents an integer of 0 to 20, preferably, 1 to 10 and, more preferably, 1 to 8.

In the formula (I), in a case where m and/or n is 0, the corresponding X and/or Y represent a single bond.

W-1 and W-2 represented by the following structural formulae exemplify the nonionic surfactant preferably. m and n in the following W-2 each independently represents an optional integer from 1 to 20.

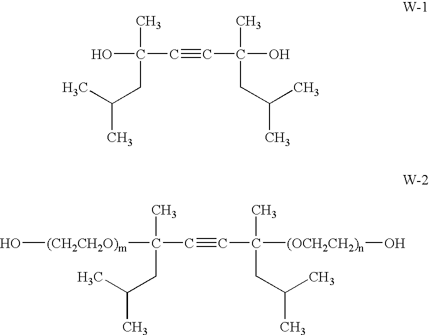

m and n in W-2 each independently represents an integer, preferably from 1 to 10 and more preferably from 1 to 8.

Further, it is preferred that m and n are identical.

The compound represented by the formula (I) in the invention is, more preferably, a combination of the preferred components described above.

While the nonionic surfactant described above can be synthesized by known methods, commercial products may also be used.

One of the compounds represented by the formula (I) may be used, or two or more of them may be used combined in any desired ratio.

The added amount of the compound represented by the formula (I), based on the solid mass in the cleaning solution is, preferably, from 0.01 to 5% and, more preferably, from 0.05 to 3%.

It is preferred that the content of the compound represented by the formula (I), based on the mass of the cleaning solution is usually from 0.0001% to 1%, preferably from 0.0003% to 0.1%, and most preferably from 0.001% to 0.05%.

### [(B) Organic Acid]

The cleaning solution of the invention contains an organic acid for effectively suppressing etching, etc.

The organic acid of the invention is an organic compound showing acidity (pH<7) in water, and having acidic functional group such as a carboxy group, a sulfo group, a phenolic hydroxyl group, and a mercapto group.

The organic acid contained in the cleaning solution of the invention is not particularly limited, and is preferably an organic carboxylic acid having a carboxyl group in a molecule, and an organic acid selected from the following group are more preferable.

Preferable examples of the organic carboxylic acid of the invention include formic acid, acetic acid, propionic acid, oxalic acid, butyric acid, valeric acid, 2-methyl butyric acid, n-hexanic acid, 3,3-dimethyl butyric acid, 2-ethyl butyric acid, 4-methyl pentanic acid, n-heptanic acid, 2-methyl hexanic acid, n-octanic acid, 2-ethyl hexanic acid, benzoic acid, glycolic acid, salicylic acid, glyceric acid, malonic acid, succinic acid, glutaric acid, adipinic acid, pimellic acid, maleic acid, phthalic acid, malic acid, tartaric acid, citric acid, and lactic acid.

Among them, acetic acid, propionic acid, oxalic acid, succinic acid, malonic acid, citric acid, tartaric acid, and malic acid are preferable as the organic acid of the invention.

One of these organic acids may be used, or two or more of them may be used combined in any desired ratio.

The content of organic acid in the cleaning solution of the invention is preferably in a range of form 0.01 to 30 mass % with respect to the total mass amount of the cleaning solution, more preferably 0.05 to 10 mass %, and particularly preferably 0.1 to 2 mass %.

### [(C) Polyethyleneglycol]

The cleaning solution of the invention contains a polyethylene glycol with a number average molecular weight of 5,000 or less for preventing traces of mist from being left as water marks, surface roughness of a polished substrate, etc.

A polyethylene glycol with a number average molecular weight of 100 to 5,000 including also low molecular weight materials such as diethylene glycol (molecular weight: 106.12), and triethyleneglycol (molecular weight: 150.18) is preferred, more preferably from 1,000 to 5,000, still more preferably from 100 to 2,000, and most preferably from 100 to 1,000 are used.

Those with the number average molecular weight exceeding 5,000 are not practical since they cause water marks when applied to a substrate having an oxide film such as TEOS on the surface.

One of (C) the polyethylene glycol may be used, or two or more of them may be used in combination.

The content of (C) the polyethylene glycol in the cleaning solution of the invention, based on mass of the cleaning solution, is usually from 0.0001% to 1.0 mass %, preferably from 0.0005% to 0.5%, and still more preferably from 0.001% to 0.1%.

The pH of the cleaning solution of the invention is 5 or less. In a case where pH exceeds 5, excess metal (metal pollutant) can not be removed sufficiently. In the neutral region of PH 5 to 9, the zeta potentials at the surfaces of the copper metal and the particle are of opposite signs, and particles tend to be adsorbed to the surface of the copper metal and are difficult to be removed owing to this. In a case of an alkaline pH region of 9 or more, corrosion occurs on the surface of the copper metal.

Among all pH values, pH 1 to 5 is preferred since corrosion on the surface of the substrate can be prevented and excess metal can be removed sufficiently.

The pH value described above can be attained by the addition of the organic acid.

Further, while a usual pH controller can also be used upon the cleaning solution of the invention, a more remarkable effect is attained if it is not used. The pH controller referred to here includes inorganic acids such as nitric acid or sulfuric acid in the case of acidification, and potassium hydroxide or ammonium in the case of alkalization.

The cleaning solution of the invention is an aqueous solution. That is, the necessary ingredients described above are preferably dissolved in an aqueous solution. Where water is used as the solvent, deionized water or super pure water which itself does not contain impurities at all, or has as few as possible is used preferably in view of the desired effect. Further, also from this point of view, electrolyzed ionic water obtained by electrolysis of water or hydrogen water in which hydrogen gas is dissolved in water can also be used.

### [Other Components]

The cleaning solution of the invention may contain other compounds as required within a range not spoiling the effect, in addition to the essential components of the compound represented by formula (I), the organic acid, and water as solvent. Usable components are described below.

### (Surfactant)

The invention preferably contain a surfactant different from the compound represented by formula (I).

The surfactant usable in the invention is not particularly limited, and includes anionic surfactant, nonionic surfactant, cationic surfactant, and amphoteric surfactant.

The anionic surfactant includes an alkyl sulfonic acid and its salt, an alkyl benzene sulfonic acid and its salt, an alkyl diphenyl ether disulfonic acid and its salt, an alkyl methyl tauric acid and its salt, an alkyl sulfuric ester and its salt, an alkyl ether sulfuric ester and its salt, and a sulfosuccinic diester and its salt.

The nonionic surfactant includes a polyoxy ethylene alkyl ether, a polyoxy ethylene fatty acid ester, and other alkylene oxide surfactants.

The cationic surfactant includes an amine salt type surfactant, and a quaternary ammonium salt type surfactant.

The amphoteric surfactant includes an amino acid type amphoteric surfactant, and a betaine type amphoteric surfactant.

As the surfactant, the anionic surfactant is preferable. Further preferable examples include an alkyl benzene sulfonic acid having 8 to 12 carbon atoms and its salt, an alkyl diphenyl ether disulfonic acid having 8 to 12 carbon atoms and its salt, an alkyl methyl tauric acid having 8 to 12 carbon atoms and its salt, an alkyl sulfuric ester having 8 to 12 carbon atoms and its salt, an alkyl ether sulfuric ester having 8 to 12 carbon atoms and its salt, a sulfosuccinic diester having 8 to 12 carbon atoms and its salt, and the like. These surfactants may be used alone or in combination of two or more.

The content of surfactant in the cleaning solution of the invention is generally 0.0001 to 1 mass % with respect to the total mass of the cleaning solution, preferably 0.0003 to 0.1 mass %, and more preferably 0.001 to 0.05 mass %.

### {Chelating Agent}

The cleaning solution of the invention may contain a chelating agent, if necessary, for reducing adverse effect caused by mixing of polyvalent metal ions. As the chelating agent, a generally demineralizing agent for hard water hard water may be used for a precipitation preventing agent of calcium and magnesium or a related compound thereof. The agent may be used alone, or in combination of plural kinds of the components as needed. The addition amount of the chelating agent is not restricted, as long as the amount is sufficient for blocking metal ions such as contaminated polyvalent metal ions, and is generally about 5 ppm to 10000 ppm in the cleaning solution.

### [Cleaning Method for Substrate for Use in Semiconductor Device]

The cleaning method of a substrate for semiconductor device use of the invention is carried out immediately subsequent to a chemical mechanical polishing process in the production of a semiconductor device, and the cleaning solution of the invention is used.

The cleaning solution of the invention is preferably used for cleaning a substrate for semiconductor device use having formed on the surface thereof a metal layer or metal compound layer, or wiring composed of them.

The substrate for use in the semiconductor device as an object to be cleaned to which the cleaning solution of the invention is applied is a substrate subjected to a chemical and mechanical polishing process in the semiconductor device production process which may be either a single layer substrate in which metal circuits are formed on the substrate surface, or a multi-layered circuit substrate in which circuits are formed with insulating films etc. therebetween, on the surface.

Usually, a CMP process is a polishing process of supplying a polishing liquid to a polishing pad placed on a polishing platen; bringing the polishing pad into contact with a surface to be polished of an object to be polished such as a substrate for semiconductor device use, and relatively moving the surface to be polished and the polishing pad. In the subsequent cleaning process, generally, the polished substrate for semiconductor device use is put on a spinner, and the cleaning solution is supplied onto the surface to be polished and onto the back side of the substrate at flow rate of 100 to 2000 ml/min, and the substrate is brush scrubbed for 10 to 60 seconds at room temperature.

A commercial cleaning machine, for example, a wafer cleaning machine (trade name: ZAB8W2M, manufactured by MAT) may be used, and scrub cleaning may be carried out with contact of a PVA roll brush used in the scrub section of the cleaning machine.

Examples of the metal used in the substrate for semiconductor device use to be polished are metals mainly of W or Cu. Recently, it has become possible to develop LSIs using copper of low wiring resistance. With the recent trend to finer widths of wiring for increasing the density, it is required to enhance the conductivity of copper wiring and resistance to electron migration, and, for such materials of high precision, technology for high productivity processing that does not cause contamination is required. In the processes for cleaning a substrate having Cu formed on the surface, or a substrate having an insulation film of low dielectric constant as an interlayer insulation film and having a copper wiring formed on the surface thereof, in particular in cleaning processes that are conducted after chemical-mechanical polishing (CMP) processing of a Cu film, or cleaning processes that are conducted after opening holes in the interlayer insulation film on the wiring by dry etching, in these cleaning processes it is particularly important to have efficient removal of impurity metals and particles left over on the surface for the sake of purity and precision of wiring, and the cleaning solution of the invention is preferably used in these cleaning processes from such point of view.

To confirm the effectiveness of impurity removal in the cleaning process, foreign matter on a wafer must be detected. In the invention, a light scatter type foreign matter measuring instrument (for example, Trade Name: SP1TBI; manufactured by KLA Tencor) is preferably used as a foreign matter detecting device. In this system, to detect foreign matter on the wafer, a laser beam is emitted to the wafer surface, and, instead of detecting the normal reflected light of the laser beam, the light intensity of the scattered laser beam is measured by a photo detector disposed in a predetermined direction is measured, thereby detecting that there is foreign matter on the wafer. The laser beam sequentially scans the wafer surface, but if an uneven portion such as foreign matter exists on the wafer surface, a change in the scattering intensity occurs. In this system, the light scattering intensity is compared with light scattering intensities preliminarily calibrated using standard particles, and the light scattering intensity is converted into a standard particle, and the size and position of foreign matter can be displayed.

In addition, by water mark evaluation described in the following examples, the state of an object surface after cleaning can be determined.

According to the cleaning method using the cleaning solution of the invention, impurity metals and particles, left on the surface of substrate for semiconductor device use after planarizing process by CMP, can be removed efficiently. The cleaning method using the cleaning solution of the invention is particularly suitable for devices which require efficient removal of impurities at each process, in particular when planarizing for a device demanding high precision of wiring, or for a multilayered wiring board forming an interlayer insulation film and then new wiring after planarizing of single-layer substrate. Further, water marks are not formed as well.

### EXAMPLES

The present invention is described by way of examples below. The invention is not restricted to the examples.

### (Preparation of Polishing Liquid)

| | | |
|---|---|---|
| Abrasive grains: Colloidal Silica (average grain size: 30 nm) | 5 | g/L |
| Benzotriazole (BTA) | 1 | g/L |
| 30 mass % hydrogen peroxide (oxidizing agent) | 15 | g/l |
| Glycine | 10 | g/L |

Pure water was added to make the entire amount 1000 mL and pH was adjusted to 6.8 by using nitric acid and ammonia.

### <Polishing of Cu Wafer>

Using an apparatus “LGP-613” manufactured by Lapmaster SFT Corp. as a lapping apparatus, films disposed to each of wafers were polished under the following conditions while supplying the polishing liquid obtained as described above.

### Substrate: Silicon wafer with 8 inch copper film

Rate of rotation of table: 50 rpm
Rate of rotation of head: 50 rpm
Polishing pressure: 168 hPa
Polishing pad: Product No. IC-1400, manufactured by Rodel Nitta Co.
Slurry feed rate: 200 ml/min

### Examples 1 to 7, Comparative Examples 1 to 9

### <Preparation of Cleaning Solution>

### (B) Organic acid or organic alkali (compound shown in Table 1)

(Amount described in Table 1)

### (A) Nonionic surfactant represented by the formula (I) (specified compound) or comparative surfactant (compound shown in Table 1)

(Amount described in Table 1)

### (C) Polyethylene glycol

(Amount described in Table 1)

Pure water was added to make the entire amount to 1,000 mL. In the following Table 1, W-1 and W-2 are examples of compounds for (A) and the specified compound and the structures thereof are shown by indicating the addition numbers (m, n) of the ethylene oxide structure units together. Further, in Table 1, TMAH represents tetramethyl ammonium hydroxide and TEAH represents tetraethyl ammonium hydroxide.

### <Cleaning Test>

A cleaning test was conducted by using cleaning solutions of Examples 1 to 7 and Comparative Examples 1 to 9 prepared according to the formulation described above, and cleaning the silicon substrate with the copper film polished under the conditions described above using the polishing liquid described above.

Cleaning was conducted by scrub cleaning comprising contacting a roll brush made of PVA with the substrate placed in a scrubbing portion incorporated in a wafer cleaning apparatus (ZAB8W2M) manufactured by MTA Co. Each of the cleaning solutions was mixed and diluted with 20 times by volume of pure water before use and supplied at 650 ml/min for the upper side and at 500 mL/min for the lower side of the polished substrate for 25 sec, subsequently, pure water (deionized water) was supplied at 650 ml/min for the upper side and at 500 ml/min for the lower side of the polished surface for 35 sec, and further, treatment by a spin drier incorporated in the apparatus was carried out for 30 sec.

### <Evaluation for Surface Roughness>

AFM measurement was conducted on Cu wafers cleaned and dried by the cleaning method described above, to evaluate the surface roughness. For the measurement, the Nano-R™ system manufactured by Pacific Nanotechnology Co. was used.

Evaluation was done giving A for Ra (nm) of 1.0 or less, B for 1.0 to 2.0, and C for 2.0 or more, and the results are shown in Table 1.

### <Abrasive Residue Evaluation>

Particles of 0.2 μm or larger remaining on the Cu wafer surface thus cleaned and dried were counted, and the abrasive residue was evaluated. Particles were measured by a SP1-TB1 manufactured by KLA-TENCOR.

The evaluation was ranked as A when the measured number of defects was in the range of 500 or less, B in the range of 501 to 5000, and C in the range of 5001 or more.

### <Water Mark Evaluation>

In the same way as in <Abrasive residue evaluation>, TEOS wafers (1500 nm of oxide layer (SiO₂) formed on silicon wafers) were cleaned and dried, and the state of wafer surface was visually observed, and water mark was evaluated.

High pressure water ejected from a nozzle end in a cleaning process generates a huge quantity of mist on the semiconductor substrate surface, and the majority is discharged from the exhaust port, but part is left floating in the chamber, which readheres to the semiconductor substrate surface. The mist may contain adsorbed dust from the vapor phase, and when the moisture in the mist evaporates after sticking, dust particles may be left over and stick to the semiconductor substrate surface, and visible marks are left over on the surface, which are hard to remove. If mist not containing dust adheres to the semiconductor substrate surface, when moisture is evaporates traces of the mist may be left over, which are known as water marks. If the surface is clean, then no water marks are observed, and so by the presence or absence of water marks, the presence or absence of impurities can be estimated. It is thus evaluated favorably when no water marks are found.

Evaluation was done giving “A” in the case where water marks were not present at all, “C” where they are distinctly present, and “B” where they were observed slightly but caused no practical problems.

The test results are shown together in the following Table 1.

TABLE 1

| | Organic acid/alkali | | Surfactant | | Polyethylene glycol | | | | | |
|---|---|---|---|---|---|---|---|---|---|---|
| | | Addition | | Addition | | Addition | | | Abrasive | |
| | | amount | | Amount | Molecular | Amount | | Surface | grain | Water |
| | Name | (g/L) | Name | (g/L) | weight | (g/L) | pH | Roughness | residue | Mark |
| Exam. 1 | Citric acid | 0.40 | W-1 | 0.010 | 1000 | 0.020 | 3.2 | A | A | A |
| Exam. 2 | Citric acid | 0.41 | W-1 | 0.010 | 600 | 0.020 | 3.2 | A | A | A |
| Exam. 3 | Oxalic acid | 0.71 | W-1 | 0.010 | 600 | 0.020 | 2.4 | A | A | A |
| Exam. 4 | Oxalic acid | 0.76 | W-2(m, n = 6) | 0.010 | 300 | 0.050 | 2.4 | A | A | A |
| Exam. 5 | Citric acid | 0.48 | W-1 | 0.010 | 150 | 0.050 | 3.1 | A | A | A |
| Exam. 6 | Citric acid | 0.48 | W-1 | 0.010 | 4500 | 0.050 | 3.1 | A | A | A |
| Exam. 7 | Citric acid | 0.38 | W-2(m, n = 10) | 0.010 | 150 | 0.050 | 3.2 | A | A | A |
| Comp. Exam. 1 | TMAH | 0.24 | W-1 | 0.009 | 300 | 0.015 | 11.5 | A | C | A |
| Comp. Exam. 2 | TMAH | 0.48 | W-2(m, n = 6) | 0.010 | 300 | 0.020 | 11.5 | A | B | B |
| Comp. Exam. 3 | TEAH | 0.29 | W-2(m, n = 4) | 0.010 | 600 | 0.025 | 11.3 | B | A | A |
| Comp. Exam. 4 | Citric acid | 0.43 | Dodecylbenzene | 0.012 | 150 | 0.010 | 3.1 | A | B | B |
| | | | sulfonic acid | | | | | | | |
| Comp. Exam. 5 | Oxalic acid | 0.76 | W-1 | 0.010 | — | 0.000 | 2.4 | B | A | C |
| Comp. Exam. 6 | Citric acid | 0.48 | W-1 | 0.010 | 20000 | 0.020 | 3.1 | A | A | C |
| Comp. Exam. 7 | Citric acid | 0.48 | W-1 | 0.010 | 6000 | 0.050 | 3.1 | A | A | C |
| Comp. Exam. 8 | Oxalic acid | 0.57 | — | 0.000 | 150 | 0.050 | 2.5 | C | B | B |
| Comp. Exam. 9 | Citric acid | 0.38 | — | 0.000 | 150 | 0.010 | 3.1 | C | A | B |

As shown in Table 1, by using the cleaning solution of the invention, foreign matter on the Cu wafer after polishing can be removed efficiently, and the surface is cleaned to such a level that formation of water mark can be suppressed.

The foregoing description of the embodiments of the present invention has been provided for the purposes of illustration and description. It is not intended to be exhaustive or to limit the invention to precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indication to be incorporated by reference.

What is claimed is:

1. A cleaning solution for a substrate for use in a semiconductor device, which is used after a chemical mechanical polishing process in a semiconductor device production process, the cleaning solution comprising a nonionic surfactant represented by the following formula (I), an organic acid, and a polyethylene glycol having a number average molecular weight of 5,000 or less, wherein the pH of the cleaning solution is 5 or less: 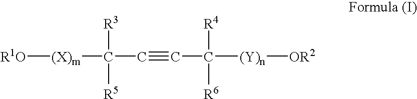
Wherein in the formula (I), R¹ to R⁶ each independently represent a hydrogen atom or an alkyl group having 1 to 10 carbon atoms, X and Y each independently represent an ethyleneoxy group or propyleneoxy group, and m and n each independently represent an integer from 0 to 20.

2. A cleaning solution for a substrate for use in a semiconductor device according to claim 1, wherein m and n in the nonionic surfactant represented by the formula (I) each independently represents an integer of from 1 to 10.

3. A cleaning solution for a substrate for use in a semiconductor device according to claim 1, wherein the organic acid is an organic carboxylic acid.

4. A cleaning solution for a substrate for use in a semiconductor device according to claim 1, wherein m and n in the formula (I) each independently represent an integer of from 1 to 8.

5. A cleaning solution for a substrate for use in a semiconductor device according to claim 1, wherein the nonionic surfactant is W-1 represented by the following structural formula:

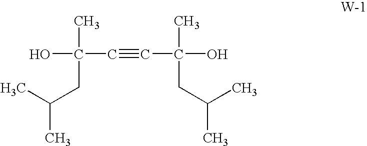

6. A cleaning solution for a substrate for use in a semiconductor device according to claim 1, wherein the nonionic surfactant is W-2 represented by the following structural formula: 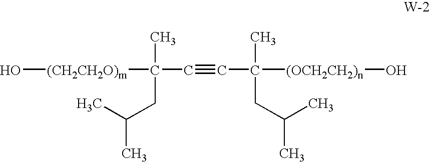
Wherein in W-2 represented by the structural formula, m and n each independently represent an integer of from 1 to 10.

7. A cleaning solution for a substrate for use in a semiconductor device according to claim 6, wherein m and n in W-2 represented by the structural formula are the same integer.

8. A cleaning solution for a substrate for use in a semiconductor device according to claim 1, wherein the number average molecular weight of the polyethylene glycol is from 100 to 5000.

9. A cleaning solution for a substrate for use in a semiconductor device according to claim 1, wherein the pH of the cleaning solution is from 1 to 5.

10. A cleaning method for a substrate for use in a semiconductor device, which uses the cleaning solution according to claim 1.
